(19) United States
(12) Patent Application Publication
(10) Pub. No.: US 2011/0032028 A1
(43) Pub. Date: Feb. 10, 2011

(54) VOLTAGE VARIATION REDUCING CIRCUIT AND SEMICONDUCTOR DEVICE USING THE SAME

(75) Inventor: Hidenari NAKASHIMA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: RENESAS ELECTRONICS CORPORATION, Kanagawa (JP)

(21) Appl. No.: 12/842,293

(22) Filed: Jul. 23, 2010

(30) Foreign Application Priority Data
Aug. 4, 2009 (JP) 2009-181848

(51) Int. Cl. G05F 3/02

(52) U.S. Cl. 327/543

(57) ABSTRACT

A voltage variation reducing circuit includes a first transistor and a second transistor. The first transistor is connected to a first power source line of a first power source voltage at a source and a second power source line of a second power source voltage at a drain and a gate. The second transistor is connected to a third power source line of a third power source voltage higher than the second power source voltage at a source and the second power source line at a drain gate.

### INCORPORATION BY REFERENCE

This application is based upon and claims the benefit of priority from Japanese patent application No. 2009-181848 filed on Aug. 4, 2009, the disclosure of which is incorporated herein in its entirety by reference.

### BACKGROUND OF THE INVENTION

1. Field of the Invention

The present invention relates to a voltage variation reducing circuit for reducing a variation in a power source voltage, and a semiconductor device using the voltage variation reducing circuit.

2. Description of Related Art

In recent years, it is required for an LSI (Large-scale Integrated Circuit) to attain the higher speed of a circuit operation and the lower power source voltage. In association with this, since a power source noise margin is decreased, a method of reducing power source noise is variously proposed. A power source noise reducing circuit is proposed as a method of dynamically reducing power source noise. In association with the high-speed operation of the LSI, a frequency of power source noise is increased. So, it is required for the power source noise reducing circuit to have a high time response property.

A patent literature 1: Japanese Patent Publication No. JP-P 2004-212387A (corresponding U.S. Pat. No. 6,823,293B2) discloses a technique with regard to a hierarchical power supply noise monitoring device and system for very large scale integrated circuits on a chip. This system includes: a plurality of noise-monitoring units (NAUs) fabricated on-chip to measure the noise on the chip and distributed strategically inside macros and cores across the chip. Each on-chip noise analyzer unit (NAU) measures the noise characteristics of signal lines, power supply voltage lines, or ground voltage on the chip. Each NAU is controlled by a higher level built-in-self-test (BIST) unit or an external tester. Each NAU includes a source of reference voltages, a noise monitoring device and a noise data latch. The supply voltage (VDD) and ground voltage (GND) are monitored by the noise-monitoring device and compared to the reference voltages. The reference voltages are controlled by a first control signal, and the output data are latched upon receiving a second control signal.

As shown in FIG. 1, the NAU 90 uses a reference voltage Vref generated in a Vref generator 91 as a reference and measures power source noise by a noise monitoring device 92 and then outputs the result to a noise data latch 93. In short, this system is the system for observing power source noise inside a chip and requires an adjustment voltage source in order to observe the power source noise.

Although this system can observe power source noise, the power source noise cannot be reduced. That is, this is the system whose object is to observe the power source noise. Thus, this does not have a circuit configuration for reducing the power source noise.

Also, a non-patent literature 1: Y. Nakamura, M. Takamiya and T. Sakurai, “An On-Chip Noise Canceller with High Voltage Supply Lines for Nanosecond-Range Power Supply Noise”, Information and Communication Engineers (IEICE)/Committee on Integrated Circuits and Devices, Technical Report Vol. 107 No. 425 discloses an on-chip noise canceller with high voltage supply lines. This on-chip noise canceller has three kinds of power source voltages, which are voltages VDD, VDDH and GND, as shown in FIG. 2. When a power source switch 97 provided between a power source line of the voltage VDD and a power source line of the voltage VDDH is operated, a current is supplied from the power source line of the voltage VDDH to the power source line of the voltage VDD, and the variation in the voltage VDD supplied to a circuit 96 is suppressed. At this time, the operation of the power source switch 97 located between the power source line of the voltage VDDH and the power source line of the voltage VDD is controlled by a level shifter 98.

Thus, although the power source switch 97 is operated, the current is supplied from the power source line on the high voltage side (VDDH) to the power source line on the low voltage side (VDD), measurement of a voltage variation, self control for the circuit based on the measurement result and the like are not executed.

It is desired to provide a technique to reduce a variation in a power source voltage while suppressing an increase a circuit area.

### SUMMARY

The present invention seeks to solve one or more of the above problems, or to improve upon those problems at least in part.

In one embodiment, a voltage variation reducing circuit includes: a first transistor configured to be connected to a first power source line of a first power source voltage at a source and a second power source line of a second power source voltage at a drain and a gate; and a second transistor configured to be connected to a third power source line of a third power source voltage higher than the second power source voltage at a source and the second power source line at a drain gate.

In another embodiment, a semiconductor device includes: a voltage variation reducing circuit configured to include: a first transistor configured to be connected to a first power source line of a first power source voltage at a source and a second power source line of a second power source voltage at a drain and a gate, and a second transistor configured to be connected to a third power source line of a third power source voltage higher than said second power source voltage at a source and said second power source line at a drain gate; and a load circuit configured to be operated by being supplied with said first power source voltage and said second power source voltage.

According to the present invention, it is possible to provide a voltage variation reducing circuit, which can reduce a variation in a power source voltage while suppressing an increase a circuit area, and the semiconductor device using the voltage variation reducing circuit.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a view showing a configuration of a hierarchy power source noise monitoring system in the patent literature 1;

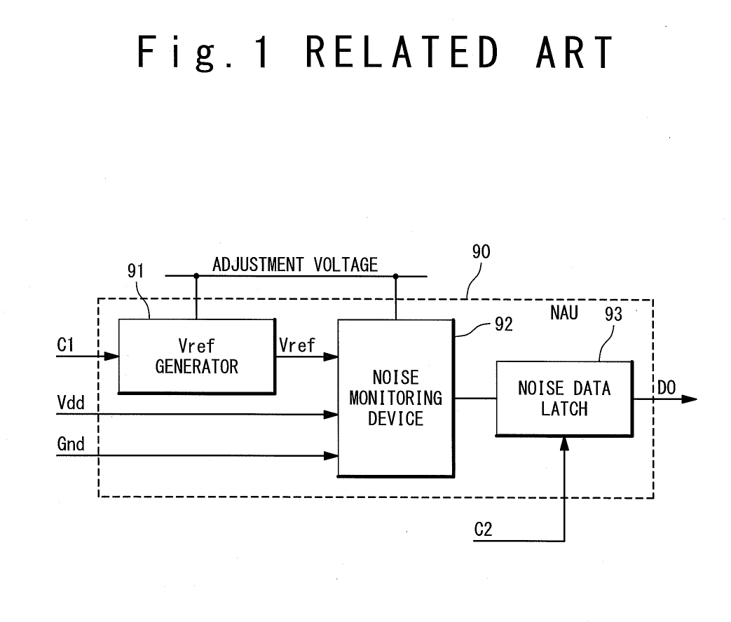

FIG. 2 is a view showing a configuration of an on-chip power source line noise canceller in the non-patent literature 2;

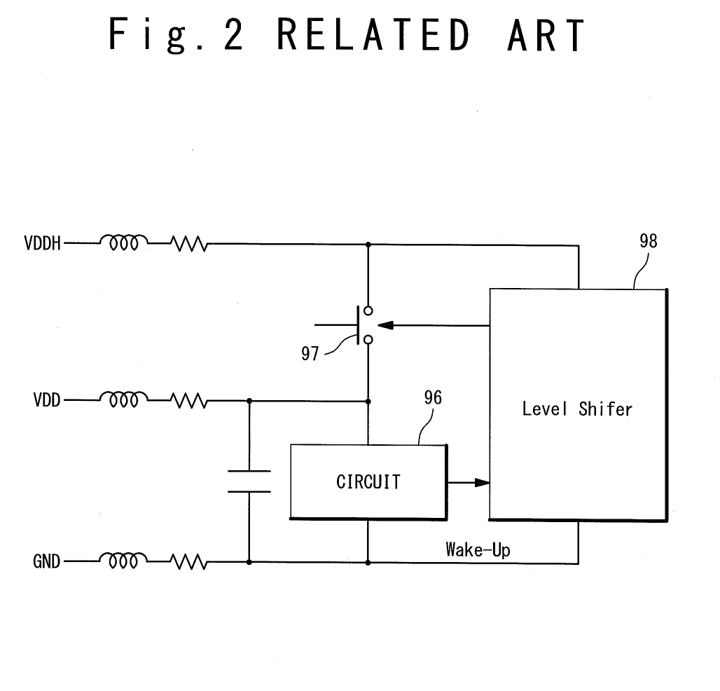

FIG. 3 is a view showing a configuration of a semiconductor device according to a first embodiment of the present invention;

FIG. 4 is a view showing a configuration of a voltage variation reducing circuit according to the first embodiment of the present invention;

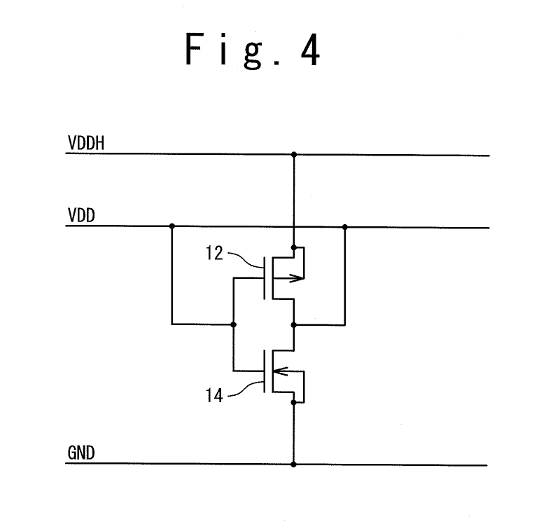

FIG. 5 is a view showing a configuration of a voltage variation reducing circuit according to a second embodiment of the present invention; and

FIG. 6 is a view showing a configuration of a voltage variation reducing circuit according to a third embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

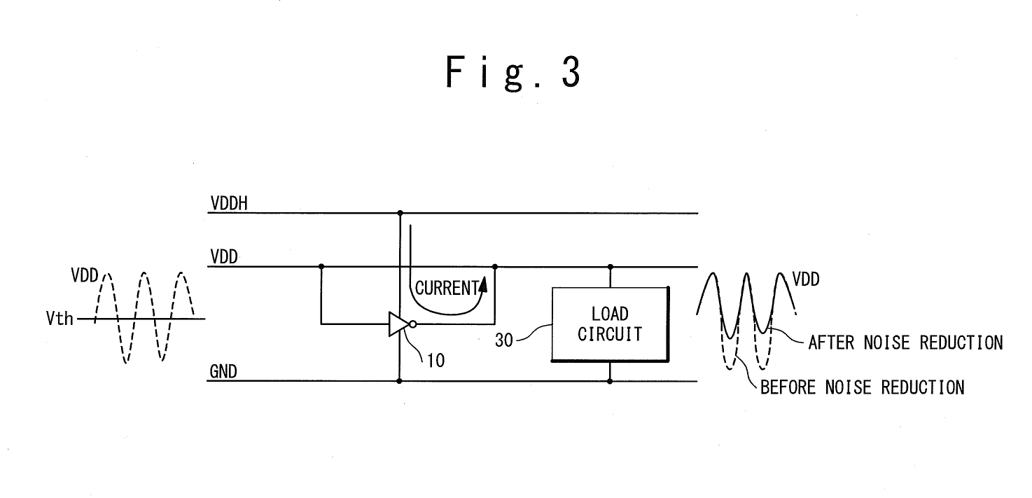

The first embodiment will be described below with reference to FIG. 3. As shown in FIG. 3, a semiconductor device according to the first embodiment includes a voltage variation reducing circuit (inverter circuit) 10 in which a voltage GND and a power source voltage VDDH higher than a power source voltage VDD serve as power sources. The voltage variation reducing circuit 10 is connected to a power source line of the voltage VDD at its input and output. The position where the input of the voltage variation reducing circuit 10 is connected to the power source line of the voltage VDD is the position where the power source voltage VDD is monitored. The position where the output of the voltage variation reducing circuit 10 is connected to the power source line of the voltage VDD is the position where a current is supplied to the power source line of the power source voltage VDD, in order to prevent a drop in the voltage VDD. The position where the input of the voltage variation reducing circuit 10 is connected to the power source line of the voltage VDD and the position where the output of the voltage variation reducing circuit 10 is connected to the power source line of the voltage VDD may be close to or away from each other.

A threshold voltage Vth of the voltage variation reducing circuit (inverter circuit) 10 is set to a voltage proximity to the power source voltage VDD lower than the voltage VDD. Thus, when the voltage value of the power source voltage VDD becomes lower than the threshold voltage Vth of the voltage variation reducing circuit 10, a current is supplied from the power source line of the high power source voltage VDDH to the power source line of the low power source voltage VDD, and the voltage drop generated in the power source voltage VDD is suppressed. When the voltage drop is small, namely, when the power source voltage VDD is higher than the threshold voltage Vth, suppression of the voltage drop is not performed.

The voltage variation reducing circuit 10 includes a P-channel MOS transistor 12 and an N-channel MOS transistor 14, which are connected in series between the power source line of the power source voltage VDDH and the power source line of the power source voltage GND. The source of the P-channel MOS transistor 12 is connected to the power source line of the high power source voltage VDDH. The drains of the P-channel MOS transistor 12 and the N-channel MOS transistor 14 are connected to each other and also connected as the outputs to the power source line of the low power source voltage VDD. The source of the N-channel MOS transistor 14 is connected to the power source line of the voltage GND. The gates of the P-channel MOS transistor 12 and the N-channel MOS transistor 14 are commonly connected to the power source line of the low power source voltage VDD.

The voltage variation reducing circuit 10 suppresses the voltage drop in the voltage VDD, with the threshold voltage Vth as a judgment reference. That is, when the inputted voltage VDD is lower than the threshold voltage Vth, the P-channel MOS transistor 12 decreases on-resistance to be relatively low, and the N-channel MOS transistor 14 increases on-resistance to be relatively high. The voltage variation reducing circuit 10 increases current supply to the power source line of the voltage VDD through the P-channel MOS transistor 12 from the power source line of the voltage VDDH. Thus, the voltage drop in the voltage VDD is suppressed. Also, when the voltage VDD is higher than the threshold voltage Vth, the P-channel MOS transistor 12 increases on-resistance to be relatively high, and the N-channel MOS transistor decreases on-resistance to be relatively low. The voltage variation reducing circuit 10 supplies a current from the power source line of the voltage VDD through the N-channel MOS transistor 14 to the power source line of the voltage GND to suppress the voltage VDD from becoming high. In this way, the voltage variation reducing circuit 10 stabilizes the voltage VDD.

The threshold voltage Vth can be set to a predetermined value by adjusting a substrate bias voltage. Thus, a back bias control circuit for adjusting the substrate bias voltage may be used to control the threshold voltage Vth and change the reference voltage.

Here, a load circuit 30 is connected between the voltage VDD and the voltage GND. The load circuit 30 is the circuit that requires a locally-stabilized power source such as a PLL circuit, a clock buffer circuit and the like. In association with a variation in a current consumed in the load circuit 30, a locally temporarily variation (voltage drop) is generated in the power source voltage VDD. When the voltage VDD becomes lower than the threshold voltage Vth, the voltage variation reducing circuit 10 of the inverter circuit type supplies a current from the power source line of the voltage VDDH to the power source line of the voltage VDD to suppress the voltage drop. That is, the voltage variation reducing circuit 10 can measure the voltage variation and reduce the power source noise. Thus, the reduction can be performed even on the sharp spike-shaped voltage variation. The threshold voltage Vth serving as the judgment reference of the variation can be adjusted by changing the back bias.

Many circuits inside the LSI are operated synchronously with a clock. The frequency of the clock is very high for the sake of the high speed operation. Thus, a consumption current is varied to be synchronous with the clock, and in association with it, the power source voltage is also varied. The voltage variation reducing circuit 10 locally suppresses the voltage variation. It is preferable that the voltage variation reducing circuit 10 is properly arranged in the vicinity of a power source supply line of a circuit in which a voltage variation can be suppressed as much as possible, because a current is supplied from the power source line of the power source voltage VDDH so that the drop in the power source voltage VDD can be suppressed even though a consumption current is increased and the voltage of the power source voltage VDD is decreased.

### Second Embodiment

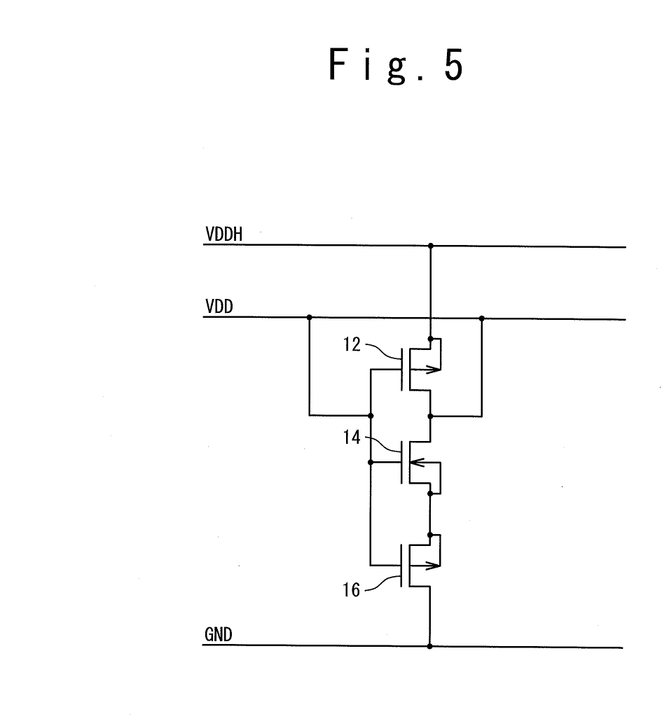

The second embodiment will be described below with reference to FIG. 5. In the second embodiment, the voltage variation reducing circuit 10 reduces a penetration current while suppressing the drop in the voltage VDD.

As shown in FIG. 5, the voltage variation reducing circuit 10 according to the second embodiment includes a P-channel MOS transistor 12, an N-channel MOS transistor 14 and a P-channel MOS transistor 16, which are connected in series between the power source line of the voltage VDDH and the power source line of the voltage GND. The P-channel MOS transistor 16 is inserted between the power source line of the voltage GND and the source of the N-channel MOS transistor 14 in the voltage variation reducing circuit 10 described in the first embodiment. The gate of the P-channel MOS transistor 16 and the gates of the P-channel MOS transistor 12 and the N-channel MOS transistor 14 are commonly connected to the voltage VDD.

Thus, the P-channel MOS transistor 12 and the N-channel MOS transistor 14 are operated as described in the first embodiment. That is, when the power source voltage VDD is lower than the threshold voltage Vth, the P-channel MOS transistor 12 decreases the on-resistance to be relatively low, and the N-channel MOS transistor 14 increases the on-resistance to be relatively high. Thus, the current is supplied from the power source line of the power source voltage VDDH through the P-channel MOS transistor 12 to the power source line of the voltage VDD, and the drop in the voltage VDD is suppressed. The P-channel MOS transistor 16 decreases the on-resistance to be relatively low similarly to the P-channel MOS transistor 12. However, since the on-resistance of the N-channel MOS transistor 14 is relatively high, the current flowing through the N-channel MOS transistor 14 to the power source line of the voltage GND from the power source line of the voltage VDDH becomes small.

When the power source voltage VDD is higher than the threshold voltage Vth, the P-channel MOS transistor 12 increases the on-resistance to be relatively high, and the N-channel MOS transistor 14 decreases the on-resistance to be relatively low. Since the P-channel MOS transistor 16 increases the on-resistance to be relatively high, the current flowing to the power source line of the voltage GND through the N-channel MOS transistor 14 from the power source line of the voltage VDDH can be decreased.

### Third Embodiment

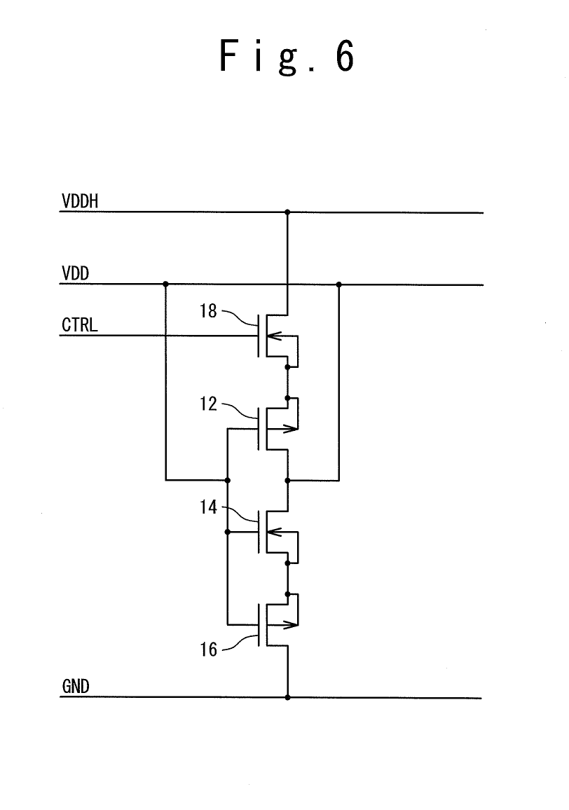

The third embodiment will be described below with reference to FIG. 6. In the third embodiment, the action of the voltage variation reducing circuit 10 is controlled.

The voltage variation reducing circuit 10 according to the third embodiment is such that an N-channel MOS transistor 18 is further added to the voltage variation reducing circuit 10 described in the second embodiment. The N-channel MOS transistor 18 is connected in series between the source of the P-channel MOS transistor 12 and the power source line of the power source voltage VDDH. Thus, the drain of the N-channel MOS transistor 18 is connected to the power source line of the voltage VDDH, and the source is connected to the source of the P-channel MOS transistor 12. A control signal CTRL is applied to the gate of the N-channel MOS transistor 18.

When the N-channel MOS transistor 18 is in an on state based on the control signal CTRL, the P-channel MOS transistors 12, 16 and the N-channel MOS transistor 14 are operated as described in the second embodiment. That is, the voltage variation reducing circuit 10 executes the operation of suppressing the voltage variation. When the N-channel MOS transistor 18 is in an off state based on the control signal CTRL, the current is not supplied to the P-channel MOS transistor 12. Thus, the voltage variation reducing circuit 10 does not execute the operation of suppressing the voltage variation.

In this way, the installation of the N-channel MOS transistor 18 controlled based on the control signal CTRL enables operational timing of the voltage variation reducing circuit 10 to be controlled as necessary. Thus, when the circuit whose power source is required to be stabilized becomes in a standby state and there is no need to suppress the voltage variation, the operation of the voltage variation reducing circuit 10 can be stopped, thereby reducing the current consumption.

As mentioned above, the present invention has been described by referring to the embodiments. It is apparent that the present invention is not limited to the above embodiment, but may be modified and changed without departing from the scope and spirit of the invention. The techniques in the above-mentioned embodiments may be combined within a range without causing any contradiction.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

What is claimed is:

1. A voltage variation reducing circuit comprising:
a first transistor configured to be connected to a first power source line of a first power source voltage at a source and a second power source line of a second power source voltage at a drain and a gate; and
a second transistor configured to be connected to a third power source line of a third power source voltage higher than said second power source voltage at a source and said second power source line at a drain gate.

2. The voltage variation reducing circuit according to claim 1, wherein said first transistor and said second transistor compose a NOT circuit,
wherein a logic threshold voltage of said NOT circuit is set to be a voltage lower than said second power source voltage, and
wherein a current is supplied from said third power source line to said second power source line through said second transistor, when said second power source voltage decreases.

3. The voltage variation reducing circuit according to claim 1, further comprising:
a third transistor configured to be inserted between said source of said first transistor and said first power source line, to be connected to said second power source line at a gate, and to have the same conductive type as said second transistor.

4. The voltage variation reducing circuit according to claim 3, further comprising:
a fourth transistor configured to be inserted between said source of said second transistor and said third power source line, to be supplied with an operation control signal at a gate, and to have the same conductive type as said first transistor.

5. The voltage variation reducing circuit according to claim 2, further comprising:
a third transistor configured to be inserted between said source of said first transistor and said first power source line, to be connected to said second power source line at a gate, and to have the same conductive type as said second transistor.

6. The voltage variation reducing circuit according to claim 5, further comprising:
a fourth transistor configured to be inserted between said source of said second transistor and said third power source line, to be supplied with an operation control signal at a gate, and to have the same conductive type as said first transistor.

7. A semiconductor device comprising:
a voltage variation reducing circuit configured to include:
a first transistor configured to be connected to a first power source line of a first power source voltage at a source and a second power source line of a second power source voltage at a drain and a gate, and
a second transistor configured to be connected to a third power source line of a third power source voltage higher than said second power source voltage at a source and said second power source line at a drain gate; and
a load circuit configured to be operated by being supplied with said first power source voltage and said second power source voltage.

8. The semiconductor device according to claim 7, wherein said first transistor and said second transistor compose a NOT circuit,
wherein a logic threshold voltage of said NOT circuit is set to be a voltage lower than said second power source voltage, and
wherein a current is supplied from said third power source line to said second power source line through said second transistor, when said second power source voltage decreases.

9. The semiconductor device according to claim 7, wherein said voltage variation reducing circuit further includes:
a third transistor configured to be inserted between said source of said first transistor and said first power source line, to be connected to said second power source line at a gate, and to have the same conductive type as said second transistor.

10. The semiconductor device according to claim 9, wherein said voltage variation reducing circuit further includes:
a fourth transistor configured to be inserted between said source of said second transistor and said third power source line, to be supplied with an operation control signal at a gate, and to have the same conductive type as said first transistor.

11. The semiconductor device according to claim 8, wherein said voltage variation reducing circuit further includes:
a third transistor configured to be inserted between said source of said first transistor and said first power source line, to be connected to said second power source line at a gate, and to have the same conductive type as said second transistor.

12. The semiconductor device according to claim 11, wherein said voltage variation reducing circuit further includes:
a fourth transistor configured to be inserted between said source of said second transistor and said third power source line, to be supplied with an operation control signal at a gate, and to have the same conductive type as said first transistor.
